(19) United States
(12) Patent Application Publication
(10) Pub. No.: US 2025/0128364 A1
(43) Pub. Date: Apr. 24, 2025

(54) Welding Clamp With Position Shifting Base

(71) Applicant: Fireball Tool Works LLC, Santa Fe Springs, CA (US)

(72) Inventor: Jason A Marburger, Spokane, WA (US)

(73) Assignee: Fireball Tool Works LLC, Santa Fe Springs, CA (US)

(21) Appl. No.: 19/005,465

(22) Filed: Dec. 30, 2024

Related U.S. Application Data
(63) Continuation-in-part of application No. 17/508,210, filed on Oct. 22, 2021, now abandoned.

(51) Int. Cl. B23K 37/04

(52) U.S. Cl. CPC B23K 37/04

(57) ABSTRACT

The present invention has a block with a cylindrical stud and a cylindrical hole. A hex-head screw has a screw head portion, a middle portion and a threaded portion. The threaded portion of the hex-head screw can be fitted to the base of a clamp through the cylindrical hole, so that the clamp can freely rotate, using the cylindrical stud as a pivoting point, and the clamp's location on a welding table can be shifted to provide a proper location on the surface of a workpiece. The cylindrical stud has an overall length sufficient to extend through the thickness of a welding table opening, where a matching lock nut can be easily used to screw on to threaded portion of the stud, thus tightening the clamp in place. When the clamp handle is engaged, the cylindrical stud, even if the lock nut is not used, binds to a welding table opening, but when the clamp handle is disengaged, the clamp can rotate as the cylindrical stud rotates in the welding table opening without angle limitation.

### CROSS-REFERENCE TO RELATED APPLICATIONS/PRIORITY CLAIM

Present application claims priority from and is a continuation in part of co-pending United States utility patent application entitled Welding Clamp With Position Shifting Base by same inventor Jason Marburger, filed on Oct. 22, 2021, application Ser. No. 17/508,210. Said priority application in turn claimed priority of an earlier application entitled Position Shifting Base by the same inventor, filed on Nov. 5, 2018, having application number of 16/180,886. The disclosure of the priority applications is incorporated herein by reference.

### DISCUSSION OF AND DISTINCTION TO RELATED ART

A variety of different accessories can be attached to a welding table. On such a welding table, clamps can be inserted to the holes on the table top to clamp on workpieces. Generally, the holes on a typical welding table are two inches apart from the one next to it.

The welding tables also may come in different thickness, from a quarter inch to over an inch in thickness. The varying thickness oftentimes create issues when a worker/operator has the need to secure a clamp on the work table for safe operation while maintaining the ease/convenience of setting and changing locations of the clamp relative to the work piece(s).

Although not analogous, due to its application in woodworking rather than welding, United States Patent Publication to Clark 2016/0046001 (“Clark 001”) by applicant Kreg Enterprises, Inc. published Feb. 18, 2016, disclosed a clamp that relied upon an expandable locking mechanism with an anchor which includes a mounting plate. A renowned supplier of carpentry equipment, Kreg uses a rotating anchor mechanism that firmly grips to the workbench and a locking clamp that locks the clamp to the workpiece. While the Kreg clamp is superior for overcoming vibrations common to carpentry, it uses a complicated anchor mechanism (20) and expansion mechanism (160) to anchor/lock the clamp to a work table surface and keep the clamp setup tightened where the locking is done by expanding the plurality of wedges (180) to tightly attaching to the holes on the table surface.

This anchor/expansion mechanism, with essential disclosures made in paragraphs [0077], [0078] and [0139], is complicated and prone to have malfunctions after repeated uses.

Present application adopted a locking mechanism that is much simplified, going in the opposition direction of Clark 001 to avoid such complicated expansion mechanism.

Another potential art is Iwata (US 20070267797) (“Iwata 797”). While the disclosure related to a general-purpose clamp, Iwata 797 has a built-in angle-limitation, referred to as a rotary range limitation means 130, as specifically defined in paragraph [0036], so that the pressing body 5's movement (the rotating angle) is limited by the interaction of the projection 131 and the recess 132, achieving the intended range limitation.

Iwata 797 further adopted a cam mechanism 141 (which is part of an interlocking means 140) where the different incline angles cause the pressing body 5's movement to happen at different speeds, as described in paragraph [0038]. Present application's movement mechanism does not include such feature, so that the movement and setting of the clamp and the shifting base is uniformly controlled by a user/worker, without any inherent speed impact by the design.

As such, present application's design allows wider freedom of the use of the clamp, when in conjunction with the shifting based, to set and operate from at a desired angle and movement speed as a worker may desire to set, without a range limitation or influence by a cam design as the teachings shown in Iwata 797.

### BACKGROUND OF THE INVENTION

Present invention relates to a welding clamp with accessory position shifting base for use on a welding table. While most welding tables have a thickness of 0.5 inch, there are variants. The welding clamp with the position shifting base of present application can be used on welding tables of different thickness.

Generally, the holes on a typical welding table are two inches apart from the one next to it. However, given the fixed formation of the matrix-like holes on a welding table, work pieces will differ in sizes and shapes, and under different circumstances, sometimes it becomes difficult for the clamp jaw of the clamp to land on the proper location of the work piece(s) to clamp firmly. Also, depending on work progress, a user may need to change/adjust the clamp jaw and/or the clamp arm position for smoother operations.

The present invention allows a much wider freedom of operation to select, set or adjust a work piece to a precise location, or offset to a location, where the clamp can provide a proper and firm clamping, with easy locking to secure the clamp in place all with the convenience and flexibility of changing/shifting the location of the base and the clamp for more versatile uses.

### SUMMARY OF THE INVENTION

The invention involves a welding clamp with additional function of location/base shifting that relies on a substantially rectangular block with a cylindrical stud and a cylindrical hole. The cylindrical hole is made in the same axial direction as said cylindrical stud and through the body of said block. A hex-head screw can be inserted through the cylindrical hole to attach the present invention to the bottom of a clamp.

The hex-head screw has an indent hex shape to receive a hex driver. The hex-head screw comprises a screw head portion, a middle portion and a threaded portion. The threaded portion of the hex-head screw can be fitted to the base of a clamp (which will have thread lines matching the thread lines of the threaded portion of the hex-head screw) through the cylindrical hole, so that the clamp can freely rotate, using the cylindrical stud as a pivoting point, and the clamp's location on a welding table can be shifted to provide a proper location on the surface of a workpiece.

In the description given in this application, the up, down, upper, lower, or bottom terms are given in a common perspective where the gravity direction will be down and the opposite direction will be up.

It is an object of the present invention to provide finer adjustment capability for the rectangular array formation welding table openings that are arranged as a regular matrix so as to adapt to small workpieces. It is an object of the present invention to provide an offset and angle to the position of the clamp. It is an object of the present invention to implement a tight and secure clamping arrangement to a work table by a thread-and-nut design, instead of relying on complicated expansion mechanism. It is an object of the present invention to allow wider freedom of use of the clamp without an angle limitation. It is an object of the present invention to allow a one-handed operation to disengage the clamp and swivel the clamp from the clamp locking handle.

### SUMMARY OF THE CLAIMS

A welding clamp with a position shifting base includes a clamp having a clamp arm with a clamp engaging tip. The clamp arm is mounted at a locking handle pivot to a clamp locking handle. The clamp arm is locked into an engaged position from a disengaged position via a clamp locking handle, The clamp arm is mounted to a clamp base at a clamp arm pivot. A base holder is formed as a block body and the block body is engaged to the clamp base. A cylindrical stud extends downwardly from a bottom side of the block body. The cylindrical stud is configured to extend into a welding table opening; the cylindrical stud has a sidewall portion and a threaded portion with total sufficient length to extend through the welding table openings (holes) on a welding table. A lock nut, with matching inner thread to the stud's threaded portion is provided so that it can be tightened, by fingers or tools, to the stud from under a welding table, serving to secure the clamp and the shifting base in any desired location as set by an operator/user.

The block body is configured to rotate freely on the welding table when the clamp is in the disengaged position. The cylindrical stud is inserted, and binds to, the welding table opening when the clamp is engaged to the engaged position. A cylindrical hole is made in the same axial direction as the cylindrical stud and through the block body. The cylindrical hole is divided into a upper portion and a lower portion. A screw is sized to fit through the cylindrical hole and the screw is longer than the thickness of the block body and has a screw head portion, a middle portion and a threaded portion. The hex-head screw is installed upside down with the threaded portion extending upwardly above the screw head portion. The threaded portion engages the clamp base.

Preferably, the screw is a hexhead screw. The cylindrical stud has a cylindrical stud sidewall portion and a threaded portion at a distend end. The cylindrical stud sidewall portion has a cylindrical stud sidewall coefficient of friction. A surface roughness of the cylindrical stud sidewall is selected to define an appropriate surface roughness to provide a cylindrical stud sidewall coefficient of friction that is high enough to bind the cylindrical stud onto the welding table opening when the clamp locking handle is engaged, even without using a lock nut to the matching threaded portion, but low enough to allow the cylindrical stud to rotate freely within the welding table opening when the clamp locking handle is disengaged.

A diameter of the screw head portion of the hex-head screw is larger than that of a diameter of the middle portion. A diameter of the middle portion is larger than a diameter of the threaded portion, and a diameter of the cylindrical hole's upper portion is sized to fit the middle portion of the hex-head screw. A diameter of the cylindrical hole's lower portion is sized to fit the screw head portion of the hex-head screw. A middle portion of the hex-head screw is not threaded.

The center line of the cylindrical stud and the centerline of the cylindrical hole are at least one inch apart. The screw is tightened so that it rigidly connects the clamp base to the block body. The clamp is configured to allow the cylindrical stud to swivel within the welding table opening in a swivel motion while maintaining a preset angle between the base holder and the clamp base when the clamp is in the disengaged position. While the lock nut is not tightened, there is sufficient play between the clamp and the welding table for the clamp to perform swivel operations as desired by a user/operator. The clamp tip has a clamp tip downward line of force parallel to an intermediate screw axis of the screw. The clamp tip downward line of force is offset from the intermediate screw axis of the screw at a clamp tip pivot offset. The base holder forms an angle to the clamp at a clamp base angle. A user can configure the clamp base angle to be facing the user during welding to provide a space for working on small or fine welds.

### DETAILED DESCRIPTION OF THE DRAWINGS

The accompanying drawings, which are incorporated in and constitute a part of this specification, illustrate and exemplify the preferred embodiments of the invention. Together with the description, serve to explain the principles of the invention.

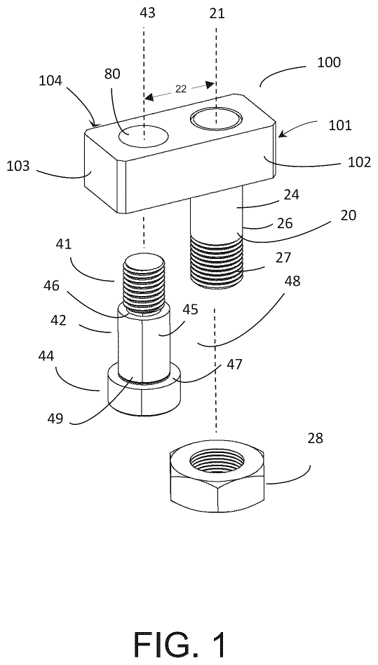

FIG. 1 is the perspective view of the present invention showing the block and the hex-head screw separated from the body of the block.

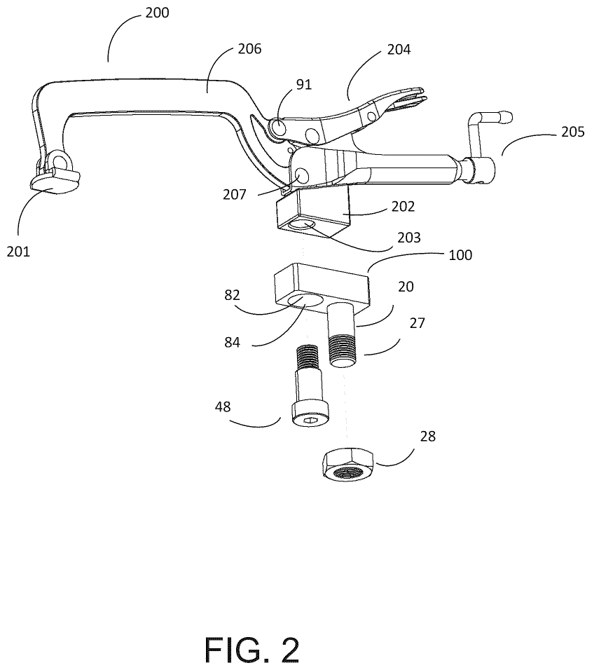

FIG. 2 is an exploded view diagram of the present invention.

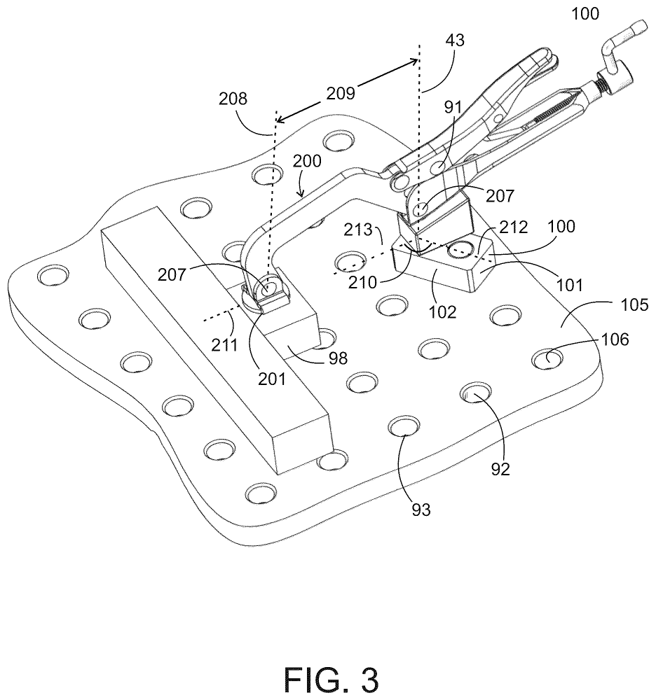

FIG. 3 is a diagram of a welding table and a clamp engaged to a small workpiece next to a larger workpiece.

The following callout list of elements can be a useful guide in referencing the element numbers of the drawings.
20 Cylindrical Stud
21 Cylindrical Stud Axis
22 Cylindrical Stud Offset
24 Stud Side Wall Portion
25 Cylindrical Stud Forward Lower Face
26 Cylindrical Stud Edge Lower Edge
27 Threaded Portion of Cylindrical Stud
28 Lock Nut
41 Threaded Portion
42 Middle Portion
43 Intermediate Screw Axis
44 Screw Head Portion
45 Smooth Portion
46 Circumferential Indent
47 Shoulder
48 Hexagonal Head Screw
49 Hexagonal Screw Forward Lower Face
80 Cylindrical Hole
82 Upper Portion
84 Lower Portion
86 Protrusion
91 Locking Handle Pivot
92 Welding Table Opening Sidewall
93 Welding Table Opening Lower Edge
98 Workpiece
100 Rectangular Block
101 Rectangular Block Rear Face
102 Rectangular Block Left Face
103 Rectangular Block Front Face
104 Rectangular Block Right Face
105 Welding Table
106 Table Opening
200 Clamp
201 Clamp Engaging Tip
202 Clamp Base
203 Clamp Attachment
204 Clamp Locking Handle
205 Clamp Adjustment Knob
206 Clamp Arm
207 Clamp Arm Pivot
208 Clamp Tip Downward Line of Force
209 Clamp Tip Pivot Offset
210 Clamp Base Angle
211 Clip Tip Forward Line of Force
212 Rectangular Block Orientation Line
213 Clamp Base Orientation Line

### DETAILED DESCRIPTION OF THE PREFERRED EMBODIMENT

The welding clamp with position shifting base of present invention has a substantially rectangular block 100, a cylindrical stud 20 extending from a bottom side of said block 100, and a cylindrical hole 80. The diameter of the cylindrical stud 20 is made to fit within the diameter of the holes on a typical welding table top. When the cylindrical stud 20 is inserted into a hole 106 on a welding table 105, the block 100 is free to rotate on the welding table 105. The cylindrical hole 80 is made in the same axial direction as said cylindrical stud 20 and through the body of said block 100, as depicted in FIGS. 1 and 2.

Also as seen in FIG. 1, a base holder such as the rectangular block 100 has orthogonal vertical sidewalls including a rectangular block rear face 101, a rectangular block left face 102, a rectangular block front face 103, and a rectangular block right face 104. Although the base holder could be formed as a differently shaped block, the rectangular block 100 is preferred because it provides the welder with a visual indication of the orientation of the base holder relative to the clamp base 202.

The cylindrical stud 20 has a sidewall portion 24 and a threaded portion, with sufficient length that the stud 20, when placed onto a welding table 105, despite the thickness may vary, the length of cylindrical stud 20 will protrude out and the threaded portion 27 extend through the bottom side of a welding table opening 106. A lock nut 28 with matching inner thread lines is provided for screwing to the threaded portion 27, sandwiching the welding table 105 in between, enabling an easy and secure way to keep the clamp secured on the welding table 105.

The cylindrical stud axis 21 and the screw axis 43 are parallel to each other and set off from each other at the cylindrical stud offset 22 which is a constant distance between the cylindrical stud axis 21 and the screw axis 43. The cylindrical stud 20 has a cylindrical stud lower edge 26 at the lower end of the sidewall 24. The hexagonal head screw 48 has a threaded portion 41, a middle portion 42 and a screw head portion 44. The middle portion 42 has a hex head screw forward lower face 49. The smooth portion 45 of the middle portion 42 has a hex head screw forward lower face 49. The smooth portion 45 and the screw head portion 44 have a shoulder 47 formed there between. The middle portion 42 has a larger diameter than the threaded portion 41, and the middle portion 42 has a small diameter than the screw head portion 44. Between the threaded portion 41 and the middle portion 42 a circumferential indent 46 can be machined to provide an indented groove.

The cylindrical hole 80 is divided into an upper portion 82 and a lower portion 84. A hex-head screw 48 is sized to fit through the cylindrical hole 80 and the hex-head screw 48 has a screw head portion 44, a middle portion 42 and a threaded portion 41.

A clamp 200 can be mounted to the block 100 by the threaded portion 41 of the hex-head screw 48. The length of the hex-head screw 48 is longer than the thickness of the body of the block 100, as shown in FIG. 2, and the threaded portion 41 will protrude out from the block 100 and for threadingly attaching to a clamp 200. The length of the screw head portion 44 can be made to be slightly shorter than the length of the lower portion 84 of the cylindrical hole 80, and the length of the middle portion 42 can be made to be slightly longer than the upper portion 82 of the cylindrical hole 80.

The diameter of the screw head portion 44 is larger than that of the middle portion 42; the diameter of the middle portion 42 is larger than that of the threaded portion 41. The diameter of the upper portion 82 of the cylindrical hole 80 is sized to fit the middle portion 42 of the hex-head screw 48. The diameter of the lower portion 84 of the cylindrical hole 80 is sized to fit the screw head portion 44 of the hex-head screw 48. The center line of the cylindrical stud 20 and the centerline of the cylindrical hole 80, as shown in FIG. 1, are one inch apart.

FIG. 3 shows a clamp being set up to clamp a small workpiece next to a large workpiece with the present invention mounted between the base of the clamp and a hole on a welding table. The base of the clamp has a threaded hole matching the dimensions of the threaded portion of the hex-head screw. As shown, the clamp is free to rotate on the present invention even after tightening the hex-head screw to the base of the clamp.

Also as seen in FIG. 3, the welding table 105 has cylindrical openings formed as welding table openings 106 for receiving the cylindrical studs 20. The welding table openings 106 have welding table openings sidewalls 92 which have a frictional engagement to the cylindrical studs 20 such that, when the lock nut 28 is not tightened to the cylindrical stud threaded portion 27, the cylindrical studs 20 can rotate in the cylindrical openings of the welding table openings 106, while allowing binding of the cylindrical studs 20 to the welding table openings 106 when the clamp locking handle 204 is engaged to an engaged position from a disengaged position. The welding table openings 106 have a welding table opening lower edge 93.

During operation, a workpiece 98 is placed under the clamp engagement tip 201 and the workpiece 98 is frictionally engaged under the clamp engagement tip 201. The clamp engagement tip 201 pushes downwardly such that the clamp engagement tip 201 has a clamping force between itself and the welding table 105. The clamp engagement tip 201 is pivot mounted at a clamp tip pivot 207 to the clamp arm 206. The clamp engaging tip 201 defines a clamp tip downward line of force 208 through the clamp engaging tip 201 when the clamp locking handle 204 engages to an engaged position. When the clamp locking handle 204 engages to an engaged position, the intermediate screw axis 43 passing through the clamp attachment 203, the clamp tip pivot 207 and the threaded portion 41, is parallel to the clamp tip downward line of force 208. A clamp tip pivot offset 209 is the distance formed between the clamp tip downward line of force 208 and the intermediate screw axis 43. The screw such as the hex head screw 48 receives a tilting torque that presses the hex head screw forward lower face 49 towards the lower portion 84 of the cylindrical hole 80. When the tilting torque is applied, the screw may not be perfectly vertically aligned but should remain generally vertical in orientation. The torque, or rotational force, also called a lever force arises when the clamp locking handle 204 is engaged.

A rectangular block orientation line 212 makes a clamp base angle 210 with the clamp base orientation line 213. During operation, a user can adjust the clamp base angle 210 and lock the clamp base angle 210 using the hex head screw 48. The user can also unlock the clamp base angle 210. The clamp base angle 210 is the angle between the clamp base 202 and the holder formed as a rectangular block body 100. With the user definable preset clamp base angle 210, the location of the clamp 200 has an angle adjustment which allows it to mount to locations that are not over the welding table openings.

The clamp tip may also have a clamp tip forward line of force 211. The clamp tip forward line of force 211 would be parallel to the clamp arm plane of movement, and form the clamp base angle 210 between itself and the rectangular block line of orientation that passes through the rectangular block from the cylindrical stud axis 21 to the intermediate screw axis 43. The cylindrical stud 20 does not slip out when the clamp locking handle 204 is engaged. The cylindrical stud 20 also receives a tilting torque that tilts the cylindrical stud lower edge 26 towards the welding table opening lower edge 93. The cylindrical stud 20 thus has a cylindrical stud sidewall 24 of an appropriate surface roughness to define a coefficient of friction that is low enough to allow ease of rotation using single-handed operation when the clamp locking handle 204 is disengaged. The surface roughness of the cylindrical stud sidewall 24 is also of an appropriate surface roughness to define a coefficient of friction that is high enough to bind the cylindrical stud 20 into the welding table opening 106 when the clamp locking handle 204 is engaged. Preferably, the hex head screw 48 is tightened so that it is rigidly connecting the clamp base 202 to the rectangular block 100.

Thus, a user can place a workpiece with a left hand, and swivel the clamp over the workpiece with the right hand, and then clamp the workpiece with the right hand all while not letting go of the workpiece with the left hand and not letting go of the clamp handle with the right hand. The user can then weld. Certainly, the left/right hand can be switched depending on dexterity and personal hand-dominance. Additionally, the lock nut 28 provides a simple way for a user, using fingers only, to secure the clamp in place when excess clamp force is needed.

After welding, the user can loosen and remove the lock nut 28, if previously tightened, unclamp and swivel the clamp away from the workpiece with the right hand while holding the workpiece with the left hand.

The clamp base angle 210 may allow more clearance for the user to work because the clamp is set at an angle further away from the user to define a concave profile. The clamp base angle 210 also provides angular adjustment when the intermediate screw axis 43 of the clamp 200 must be placed between table welding openings 106. The clamp base angle 210 is a preset angle, and the user can swivel the clamp 200 without any angle limitation when in the disengaged position while maintaining the preset angle of the clamp base angle 210. Thus, the user can swivel the clamp base at the cylindrical stud 20 which forms an axis of rotation for the clamp base after the clamp base is secured to the base holder formed as the rectangular block or a differently shaped block body.

1. A welding clamp with a position shifting base, comprising:
a clamp having a clamp arm with a clamp engaging tip, wherein the clamp arm is mounted at a locking handle pivot to a clamp locking handle, wherein the clamp arm is locked into an engaged position from a disengaged position via a clamp locking handle, wherein the clamp arm is mounted to a clamp base at a clamp arm pivot;
a base holder formed as a block body, wherein the block body is engaged to the clamp base;
a cylindrical stud extending downwardly to a bottom side of the block body, wherein the cylindrical stud is configured to have sufficient length to extend through a welding table opening with a threaded portion and a lock nut with matching inner thread lines, wherein the block body is configured to rotate freely on the welding table when the clamp is in the disengaged position, wherein the cylindrical stud binds to the welding table opening when the clamp is engaged to the engaged position;
a cylindrical hole made in the same axial direction as the cylindrical stud and through the block body, wherein the cylindrical hole is divided into a upper portion and a lower portion; and
a screw, wherein the screw is sized to fit through the cylindrical hole wherein the screw is longer than the thickness of the block body and comprises a screw head portion, a middle portion and a threaded portion, wherein the screw is installed upside down with the threaded portion extending upwardly above the screw head portion, wherein the threaded portion engages the clamp base.

2. The welding clamp with a position shifting base of claim 1, wherein the screw is a hexhead screw.

3. The welding clamp with a position shifting base of claim 1, wherein the cylindrical stud has a cylindrical stud sidewall, and wherein the cylindrical stud sidewall has a cylindrical stud sidewall coefficient of friction, wherein a surface roughness of the cylindrical stud sidewall is selected to define an appropriate surface roughness to provide a cylindrical stud sidewall coefficient of friction that is high enough to bind the cylindrical stud onto the welding table opening when the clamp locking handle is engaged, but low enough to allow the cylindrical stud to rotate freely within the welding table opening when the clamp locking handle is disengaged.

4. The welding clamp with a position shifting base of claim 1, wherein a diameter of the screw head portion of the hex-head screw is larger than that of a diameter of the middle portion, and wherein a diameter of the middle portion is larger than a diameter of the threaded portion, and wherein a diameter of the cylindrical hole's upper portion is sized to fit the middle portion of the hex-head screw, and wherein a diameter of the cylindrical hole's lower portion is sized to fit the screw head portion of the hex-head screw, wherein a middle portion of the hex-head screw is not threaded.

5. The position shifting base for a welding table of claim 1, wherein the clamp is configured to swivel around the cylindrical stud without angle limitation, while maintaining a preset angle between the base holder and the clamp base when the clamp is in the disengaged position.

6. The position shifting base for a welding table of claim 1, wherein the clamp tip has a clamp tip downward line of force parallel to an intermediate screw axis of the screw, wherein the clamp tip downward line of force is offset from the intermediate screw axis of the screw at a clamp tip pivot offset.

7. The position shifting base for a welding table of claim 1, wherein the base holder forms an angle to the clamp at a clamp base angle, whereby a user can configure the clamp base angle to be facing the user during welding.

8. The welding clamp with a position shifting base of claim 7, wherein the screw is a hexhead screw.

9. The welding clamp with a position shifting base of claim 7, wherein the cylindrical stud has a cylindrical stud sidewall, and wherein the cylindrical stud sidewall has a cylindrical stud sidewall coefficient of friction, wherein a surface roughness of the cylindrical stud sidewall is selected to define an appropriate surface roughness to provide a cylindrical stud sidewall coefficient of friction that is high enough to bind the cylindrical stud onto the welding table opening when the clamp locking handle is engaged, but low enough to allow the cylindrical stud to rotate freely within the welding table opening when the clamp locking handle is disengaged.

10. The welding clamp with a position shifting base of claim 7, wherein a diameter of the screw head portion of the hex-head screw is larger than that of a diameter of the middle portion, and wherein a diameter of the middle portion is larger than a diameter of the threaded portion, and wherein a diameter of the cylindrical hole's upper portion is sized to fit the middle portion of the hex-head screw, and wherein a diameter of the cylindrical hole's lower portion is sized to fit the screw head portion of the hex-head screw, wherein a middle portion of the hex-head screw is not threaded.

11. The position shifting base for a welding table of claim 7, wherein the center line of the cylindrical stud and the centerline of the cylindrical hole are at least one inch apart.

12. The position shifting base for a welding table of claim 7, wherein the clamp is configured to allow the cylindrical stud to swivel within the welding table opening in a swivel motion while maintaining a preset angle between the base holder and the clamp base when the clamp is in the disengaged position.

13. The position shifting base for a welding table of claim 7, wherein the clamp tip has a clamp tip downward line of force parallel to an intermediate screw axis of the screw, wherein the clamp tip downward line of force is offset from the intermediate screw axis of the screw at a clamp tip pivot offset.
